(19) United States
(12) Patent Application Publication
(10) Pub. No.: US 2023/0260712 A1
(43) Pub. Date: Aug. 17, 2023

(54) LAYERED CHARGE STORAGE DEVICE WITH TWO DIFFERENT TYPES OF ELECTRODE MATERIALS AND A PROTECTIVE ENCLOSURE

(71) Applicant: Imagine TF, LLC, Campbell, CA (US)

(72) Inventor: Brian Edward Richardson, Los Gatos, CA (US)

(21) Appl. No.: 17/669,467

(22) Filed: Feb. 11, 2022

(51) Int. Cl. H01G 4/33; H01G 4/30; H01G 4/012; H01G 4/232; H01G 4/224

(52) U.S. Cl. CPC H01G 4/33; H01G 4/012; H01G 4/224; H01G 4/232; H01G 4/306

(57) ABSTRACT

A capacitor device comprised of a first conductor layer fabricated from a first material located between two dielectric layers located between second set of conductor layers fabricated from a second material located between two additional dielectric layers and at least another two first conductors. The first conductor layers all being electrically connected to one another and the second conductor layers being electrically connected to one another and not electrically connected to the first conductor for the purpose of storing electrical charge.

### CROSS REFERENCE TO RELATED APPLICATIONS

N/A

### FIELD OF THE PRESENT DISCLOSURE

The present disclosure describes an architecture for the fabrication of capacitors or other charge storage devices. The architecture employs different types of materials for the conductive electrodes. The use of different types of materials for the electrodes allows for the selective etching of one set of conductive electrodes (anodes) independent of the other set (cathodes). Selective etching allows for the electrical isolation of a particular conductor during manufacturing. This architecture can be applied to stand alone capacitors or the type that are incorporated within an integrated circuit (IC).

### SUMMARY

Various embodiments of the present disclosure teach a capacitor generally constructed from at least two different types of electrode conductors. By deploying two different types of material selective etching can be used to selectively etch them during fabrication.

The disclosed teaching can be deployed in capacitors of almost any type where layers of electrodes are stacked on top of one another. The stacks of electrodes are configured in planar configurations. The stacked layers of alternating electrode material can also be deployed within an integrated circuit.

The deployment of the disclosed art greatly reduces the number of, and complexity of, process steps required to manufacture capacitors. Further, the technique allows for, in many cases, roll to roll fabrication of capacitors rather than a batch type approach. When the technology is integrated within an IC, the real estate required for a capacitor can be greatly reduced.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a perspective view of a chip capacitor.

FIG. 2 is a side perspective view of a section of the chip capacitor shown in FIG. 1.

FIG. 3A is a closeup view of a first end of the chip capacitor shown in FIG. 2, and FIG. 3B is a sectional view of the first end.

FIG. 4 is a closeup view of a second end of the chip capacitor shown in FIG. 2.

FIG. 5A is a side perspective view of the chip capacitor illustrated in FIG. 1, and FIG. 5B is a sectional view.

FIG. 6 is a more detailed view of the section shown in FIG. 5B.

FIG. 7A is another perspective view of a section of the chip capacitor, and FIG. 7B is a central cross sectional view of the chip capacitor.

FIGS. 8A and 8B are perspective views of an alternate embodiment.

FIG. 9A is a closeup view showing details of a first end of the alternate chip capacitor shown in FIGS. 8A and 8B, and FIG. 9B is a sectional view of the end.

FIGS. 10A and 10B are closeup views showing a section of the chip capacitor shown in FIGS. 8A and 8B.

FIG. 11A is a closeup view of a first end of the chip capacitor shown in FIGS. 8A and 8B, and FIG. 11B is a sectional view of the first end and pad.

FIG. 12A is another perspective view of the chip capacitor shown in FIGS. 8A and 8B, and FIG. 12B is a central cross sectional view.

FIGS. 13A and 13B show a perspective view and a sectional perspective view respectively of another alternate embodiment of the invention.

FIG. 14A is a closeup view of a central portion of the chip capacitor shown in FIGS. 13A and 13B, and FIG. 14B is a sectional view of the first end and pad.

FIG. 15A is a closeup sectional view of a side of the chip capacitor shown in FIGS. 13A and 13B, and FIG. 15B is a more detailed view.

FIGS. 16A, 16B, and 16C are perspective views and sectional views of another alternate embodiment of the invention.

FIG. 17 is a closeup sectional view of an end of the alternate embodiment shown in FIGS. 16A-C.

FIGS. 18A-D show another alternate embodiment in which the substrate is trenched.

FIG. 19 shows a cross section of still another embodiment of the invention.

FIG. 20 is a closeup view of the device illustrated in FIG. 19, a thin chip capacitor.

FIG. 21 shows still another embodiment of the invention, a capacitor array.

FIGS. 22A and 22B show another embodiment of the invention, a cylindrical capacitor.

FIGS. 23A and 23B show detail views of the device illustrated in FIGS. 22A and 22B.

FIGS. 24A and 24B show ribbed cylindrical embodiments.

FIGS. 25A and 25B show plated up and filled embodiments.

FIGS. 26A and 26B show an alternate plated up device.

FIGS. 27A-C show a first process step in various embodiments of the fabrication process.

FIGS. 28A-C show a second step in various embodiments of the fabrication process.

FIGS. 29A-C show a third step in various embodiments of the fabrication process.

FIGS. 30A-C show a fourth step in various embodiments of the fabrication process.

FIGS. 31A-B show a fifth step in various embodiments of the fabrication process.

FIGS. 32A-B show a sixth process step in various embodiments of the fabrication process.

FIGS. 33A-B show a seventh process step in various embodiments of the fabrication process.

FIGS. 34A-B show an eighth process step in various embodiments of the fabrication process.

FIG. 35 shows a ninth process step in various embodiments of the fabrication process.

FIG. 36 Is an electrical diagram of a capacitor and the equation to calculate capacitance.

FIGS. 37 through 41 show reference materials and prior art.

### DETAILED DESCRIPTION

Capacitors are devices that store electrical charge. Almost all electronic devices utilize capacitors. Some devices have millions of capacitors, and a DRAM IC might have more than a trillion capacitors. Similarly, an LCD display may have tens of millions of capacitors, and a PCB assembly may have hundreds of discrete chip capacitors.

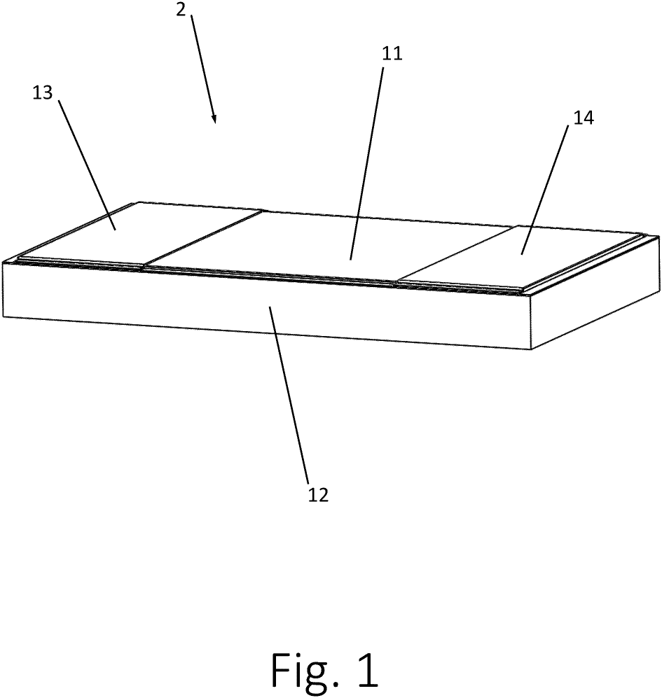

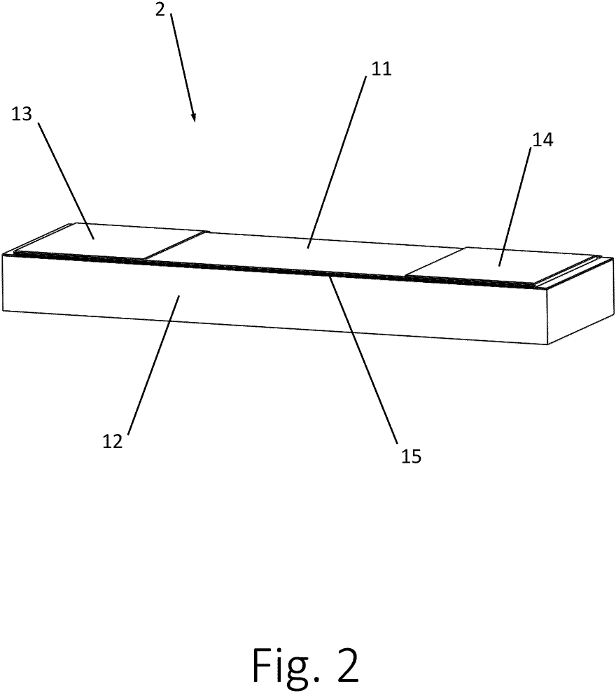

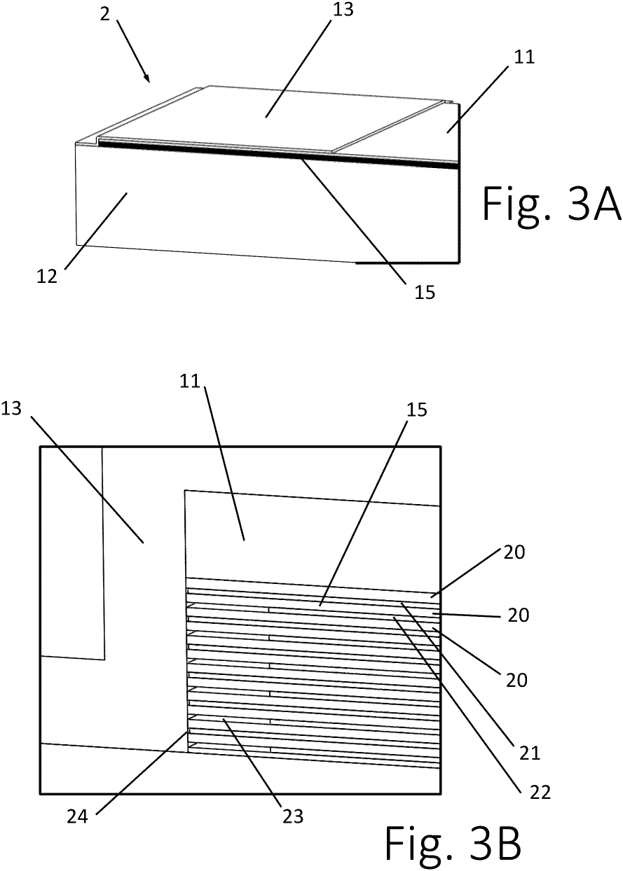

Referring first to FIG. 1, a perspective view of a chip capacitor 2, showing the external components: a top insulator 11, a substrate 12, a first plated pad 13, and a second plated pad 14 can be seen. The top insulator 11 is mated to the substrate 12 around the front and rear sides. It should be noted that the substrate 12 is not required for the function of the capacitor. However, the substrate does provide structural support during manufacturing and handling of the device. The substrate 12 is fabricated from a material that is not conductive. As indicated in FIG. 2, below the main portion of the top insulator 11, a capacitor film stack 15 is situated between the top insulator 11 and the substrate 12. The capacitor film stack 15 is shown in more detail in FIGS. 3A and 3B. The details of the capacitor film stack 15 are also depicted in magnified views described below in this disclosure.

Referring again to FIG. 2, at opposite ends of the chip capacitor 2 there are the first plated pad 13 and the second plated pad 14. The plated pads 13, 14 facilitate electrical and mechanical connections to a PCB or to another electronic device. The chip capacitor 2 might be connected to a PCB with solder or with conductive ink. Connections to the chip capacitor 2 may also be facilitated via the use of wire bonding. The technology disclosed herein can be utilized within an integrated circuit. One skilled in the art of electronic assemblies could devise many ways to connect the capacitors described herein to an electronic circuit. The plated pads 13, 14 can be plated with many materials, not all of which are discussed herein. Additional layers of nickel, copper, gold or tin may be added to what is generally disclosed for durability or to facilitate soldering.

Referring again to FIGS. 3A and 3B where a first end of the chip capacitor 2 is enlarged and sectioned so that the details of the components of the capacitor 2 can be more readily seen. In FIG. 3B the various layers of the capacitor film stack 15 can be seen. The capacitor film stack 15 is constructed with alternating planar layers of conductors and dielectrics. The top insulator 11 encloses the top, front and back sides of the capacitor film stack 15. The substrate 12 supports and encloses the bottom of the capacitor film stack 15. It can be seen from FIGS. 3A and 3B that the top insulator 11 does not enclose the first end of the capacitor film stack. The first end of the capacitor film stack 15 is enclosed by the first plated pad 13. A plurality of anode films 21 all make contact with, and perhaps more importantly make an electrical connection to, the first plated pad 13 at an anode connection 24 point. Both the plated pads 13, 14 and the anode connection 24 are electrical conductors. The dielectric films 20 are also shown as being encapsulated by and mated to the first plated pad 13. Dielectric materials are not considered conductive when compared to the conductivity of metals. Dielectric films 20 do not need to be in physical contact with conductors due to the fact that the dielectric films lack conductivity. Cathode films 22 are not in contact with the first plated pad 13. This construction means therefore yields no electrical connection between the cathode films 22 and the first plated pad 13. A cathode insulation 23 is shown between the cathode films 22 and the first plated pad 13. The cathode insulation 23 can be a vacuum, a non-conducting gas, or a nonconducting solid.

The top insulator 11 is present to insulate the capacitor film stack 15 from any factors exterior to the device. Directly below the top insulator 11 is a first one of the dielectric films 20. Directly below and mated to the first dielectric film 20 is a first one of the anode films 21. Directly below and mated to the first anode film 21 is a second dielectric film 20, and below the second dielectric film 20 is a cathode film 22 with another dielectric film 20 following below the cathode film 22. The sequence of films is repeated and ends where the bottom of the capacitor film stack 15 meets and is mated to the top surface of the substrate 12. The capacitor film stack 15 is illustrated as having six sets of films. Clearly, that number is not definitive. The chip capacitor 2 is in no way limited to embodiments utilizing six sets, or any other number, of component layers. Depending on the application and the needs of the electrical circuit in which the chip capacitor 2 is being deployed, the number of layers may range from as little as two sets to hundreds or even thousands of sets of layers. In summary, the top insulator 11, the dielectric films 20, and the anode films 21 all extend to the first plated pad 13. The anode films 20 make electrical contact with the first plated pad 13.

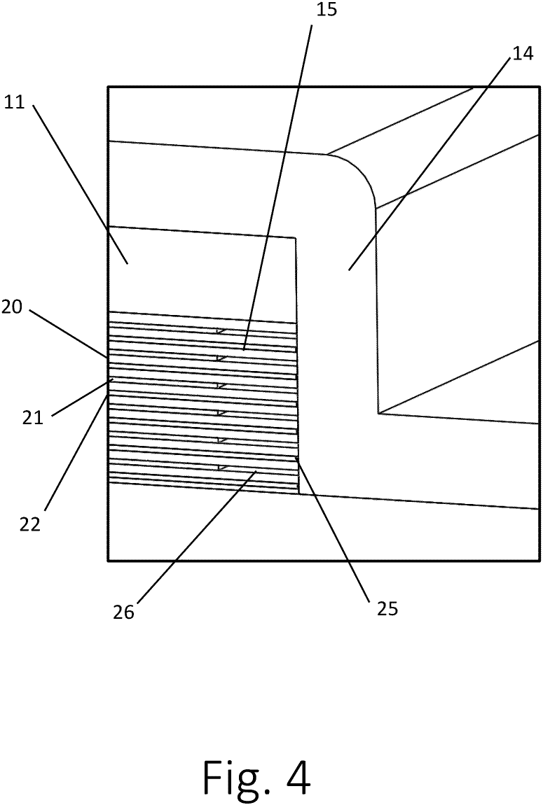

FIG. 4 shows a detailed sectional view of the second end of the capacitor 2. The second end has a mirror image configuration of the first end, with the exception that at the second end, the cathode films 22 are mated to and are electrically connected to the second plated pad 14 at the cathode connection 25. Conversely, anode films 21 are not mated to or connected to the second plated pad 14. The anode films 21 are isolated by an anode insulation 26, a section at the end of each anode film 21.

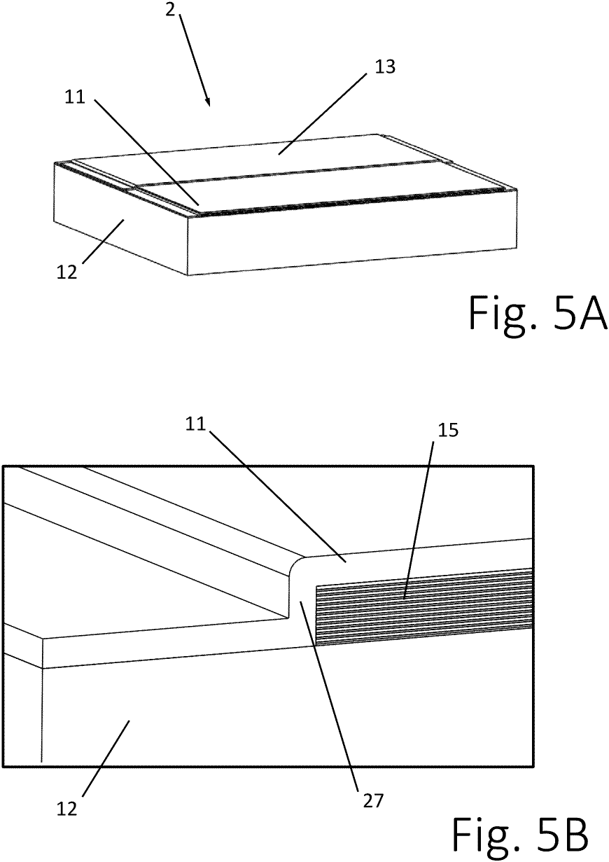

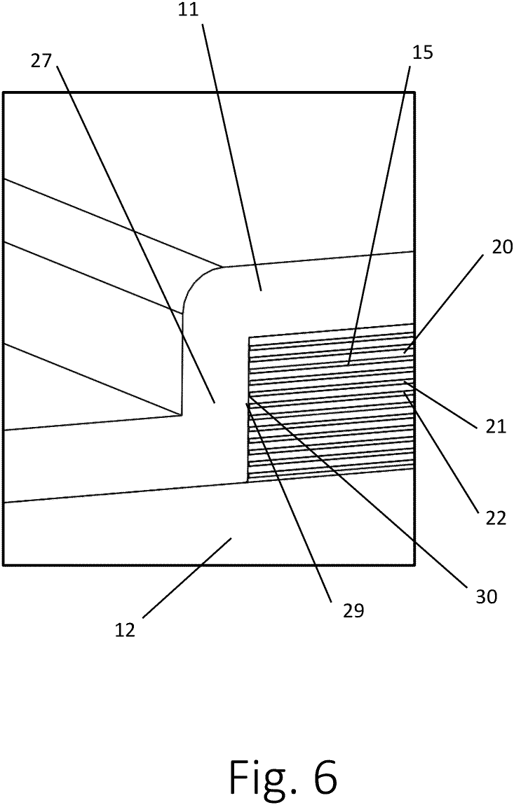

FIG. 5A is a side perspective cross section view of the chip capacitor 2. FIG. 5B and FIG. 6 show a magnified cross section view of the chip capacitor 2. In these views, the perimeter contacts of the top insulator 11 to the substrate 12 can be seen. The top insulator 11 can also be seen to be in contact with the top surface of the capacitor film stack 15. The side insulator 27 encloses the sides of the film stack 15 and is mated to all of the elements of the capacitor film stack 15. This is an important factor in providing protection for the dielectric films 15, the anode films 21 and the cathode films 22. The top insulator 11 is not conductive. Therefore, no electricity flows between the elements of the capacitor film stack 15 as there is no electrical contact points between the ends of the films in the film stack 15.

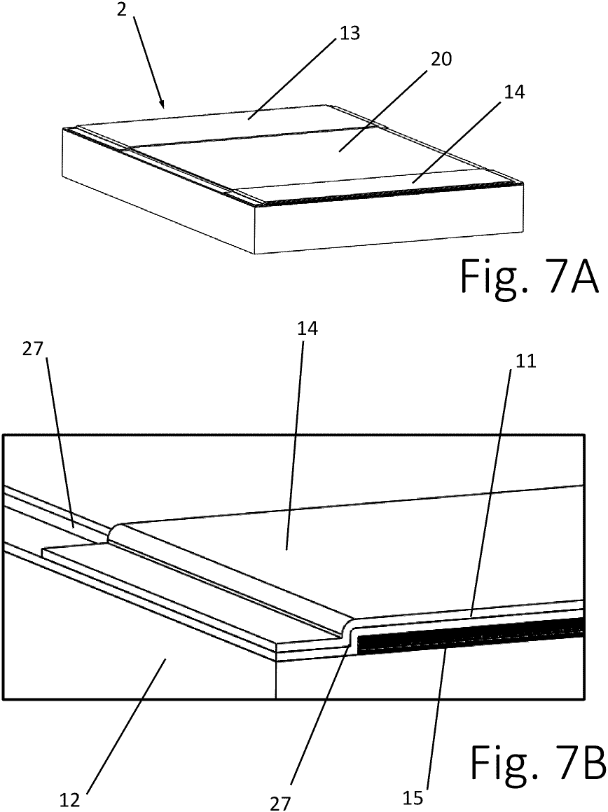

FIGS. 7A and 7B illustrate a section of the second plated pad. The orientation of the second plated pad 14 and the top insulator 11 can be seen. The top insulator 11 has the same shape, function, and dimensions as shown in drawings described above. The top insulator 11 makes contact with the substrate 12. The top insulator 11 and the side insulator 27 are shown separating and insulating the right plated pad 14 from the capacitor film stack 15 along front and rear sides of the capacitor 2. The same configuration of these elements is present at all four corners of the chip capacitor 2.

The configuration of the top insulator 11, capacitor film stack 15, and the side insulators 27 results in the electrical connection of the anode films 21 only to the first plated pads 13, and not to the cathode films 22. Similarly, this configuration ensures that the anode films 21 are not connected to the second plated pad 14, but the cathode films 22 are connected to the second plated pad 14.

For chip fabrication, it is desirable to have the capacitor film stack 15 as close as possible to the overall size of the chip capacitor 2. Current semiconductor and laser processing tools allow for capacitor film stack 15 to be almost identical in size to the overall chip capacitor 2.

The number of and thickness of the layers in the capacitor film stack 15 are not shown to scale. For most applications, the number of layers would be much greater than what has been illustrated for purposes of explanation, and the thickness would be much less. In practice, conductor layers and dielectric layers may only be a few nanometers in thickness. Thinner dielectric films equate to greater capacitance, and thinner conductor layers equate to a thinner device at a lower cost.

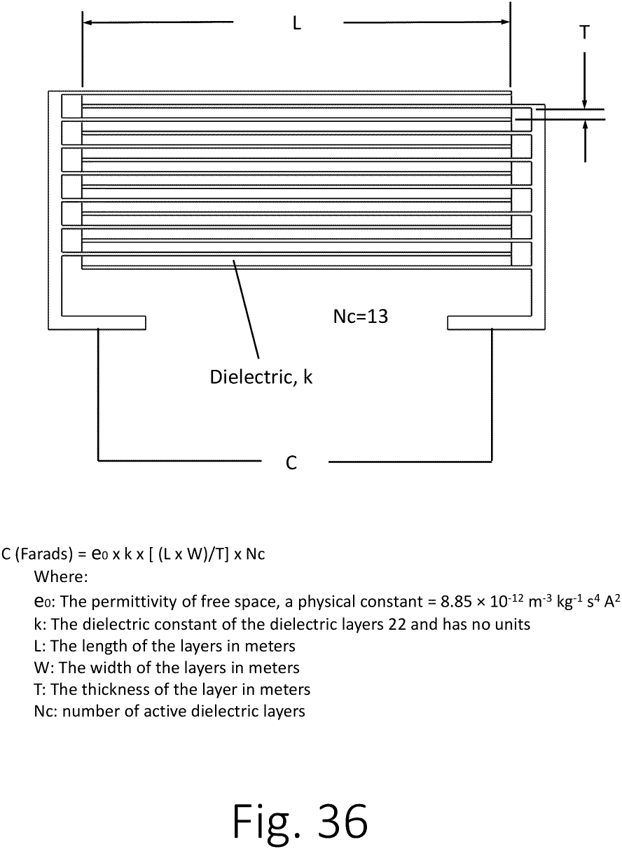

The basic function of a capacitor is to store electrical charge. A charge can be created across the dielectric layers by applying a voltage across the dielectric layers via conductors. The charge can be extracted from the capacitor for use in an electrical device. The unit for capacitance is Farads. Small capacitors may only have a fraction of a micro Farad of capacitance. Larger capacitors may have a Farad or more. The equation to determine the capacitance of a capacitor based on its geometry and physical characteristics (as shown below and in FIG. 36) is as follows:

$$\text{C} \left(\text{Farads}\right) {\text{= e}}_{\text{0}} \times \text{k} \times \left[\left(\text{L} \times \text{W}\right) / \text{T}\right] \times \text{Nc}$$

Where:
e₀: The permittivity of free space, a physical constant = 8.85 × 10-¹² m-³ kg-¹ s⁴ A²
k: The dielectric constant of the dielectric layers 22, unitless
L: The length of the layers in meters
W: The width of the layers in meters
T: The thickness of the dielectric layer in meters
Nc: number of active dielectric layers
It should be noted that it is generally desirable to have capacitors with a large amount of capacitance (farads) in as small a package as is possible.

The permittivity of free space (eo) is a physical constant and is the same for all types of capacitors of any type of construction. The dielectric constant (k) is a property of the dielectric material used in the dielectric film. Dielectric constants for dielectric materials range from around 4 for silicon dioxide to greater than 2000 for strontium titanium oxide. One skilled in the art of capacitor materials could engineer the selection of the dielectric for a particular application of the chip capacitor. The length and width and thickness of the capacitor should generally be as small as possible. Larger and thicker capacitors not only require more real estate within a PCB but utilize more material that increases the cost of the device. The number of layers (Nc) also effects the cost and to a lesser degree size.

A typical state of the art chip capacitor may have a dielectric constant, k = 1,000; length, L = 1.0 mm; width, W = 0.6 mm; dielectric layer thickness, T = 0.10 mm; and have 25 layers, Nc. A capacitor with these parameters would have a capacitance of 0.00133 micro Farads.

Utilizing the technology disclosed herein, the dielectric layers can be much thinner, T= 0.0001 mm (100 nanometers). This difference in thickness of the dielectric layers would result in a capacitor with 1,000 times the capacitance, or 1.33 micro Farads, while maintaining the same length and width and dielectric material.

The reduction in dielectric layer thickness is possible due to the manufacturing aspect of the disclosed technology. Current art requires that the dielectric layers be relatively thick. The disclosed art allows for the use of modern semiconductor type processes which can produce much thinner layers. The current state of the art of semiconductor type deposition processing allows for the deposition of one layer of atoms at a time. This allows for the creation of extremely thin conductor or dielectric films.

One skilled in the art of semiconductor deposition could engineer the ideal deposition process for a particular application of the chip capacitors disclosed herein. A capacitor that would provide the same characteristics as those described above as typical state of the art could be much smaller in area (W x L), using only 1/1,000 of the area required with prior art devices. The capacitor could be only 0.06 mm x 0.1 mm rather than 0.6 mm x 1.0 mm, and still produce ten times the capacitance.

Preferred semiconductor materials for the capacitor chip 2 include copper, silver, and / or aluminum for the conductors. All of these materials can be independently etched, and will exhibit high conductance. Other less conductive metals could be deployed as well.

Preferred dielectric materials include silicon dioxide (SiO2) and aluminum dioxide (AI2O3). Both of these materials exhibit high dielectric strength. The higher the dielectric strength the thinner the dielectric layers can be. AI2O3 has another advantage in regard to processing. A discrete film of Al2O3 can be deposited directly over the conductors. An alternate method is to deposit a thin film of Al and then oxidize it in a later step of the processing to create AI2O3. This reduces the number of materials from three to two, with an oxidizing station included in the process. Tools with only two deposition stations are less expensive and complex as compared to tools with three stations.

Silicon dioxide generally has a breakdown voltage of 1 volt per nanometer of thickness and a dielectric constant of approximately 4. A chip capacitor with SiO2 2 nanometers thick could easily operate at 1 Volt. This would meet the needs of many high-speed electronic circuits and devices. The current art chip capacitor example given above was based on a dielectric thickness of 0.10 mm (100,000 nm) and a dielectric constant of 1000. A capacitor fabricated with SiO2 2 nm thick rather than the material and thickness disclosed in the prior art example would have a capacitance 400 times that of the previously disclosed current art example. The total thickness of the dielectric stack for a chip capacitor with 2 nm thick SiO2 dielectric would be 50,000 times thinner than for a prior art chip capacitor with a 100 um (100,000 nm) thick dielectric stack.

This invention enables the use of semiconductor processing and materials to fabricate chip capacitors. The invention is not limited to the types of material discussed above. Materials used in current ceramic and polymer type chip capacitors can be deployed as well. One skilled in the art of ceramic and or polymer materials for capacitors could engineer an appropriate material set for the disclosed chip capacitor invention.

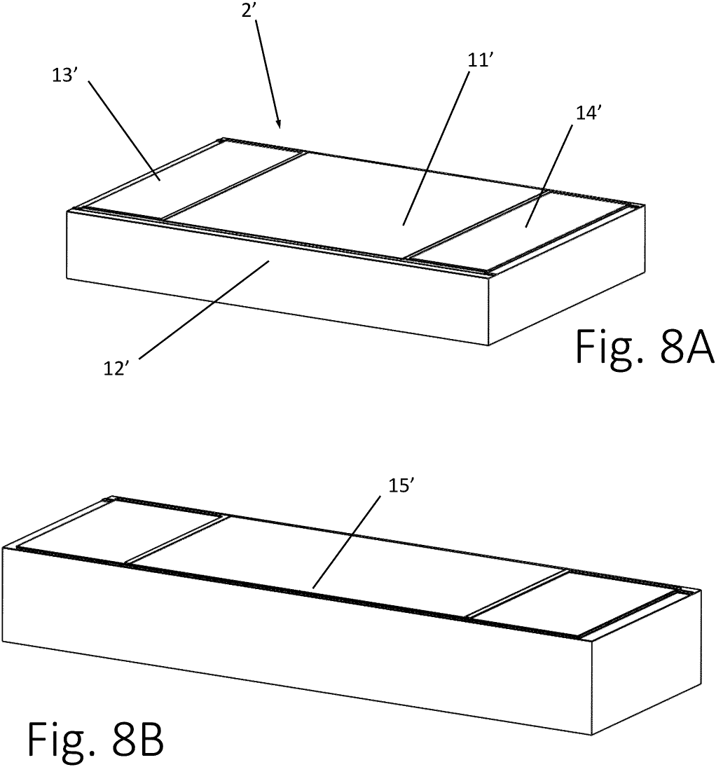

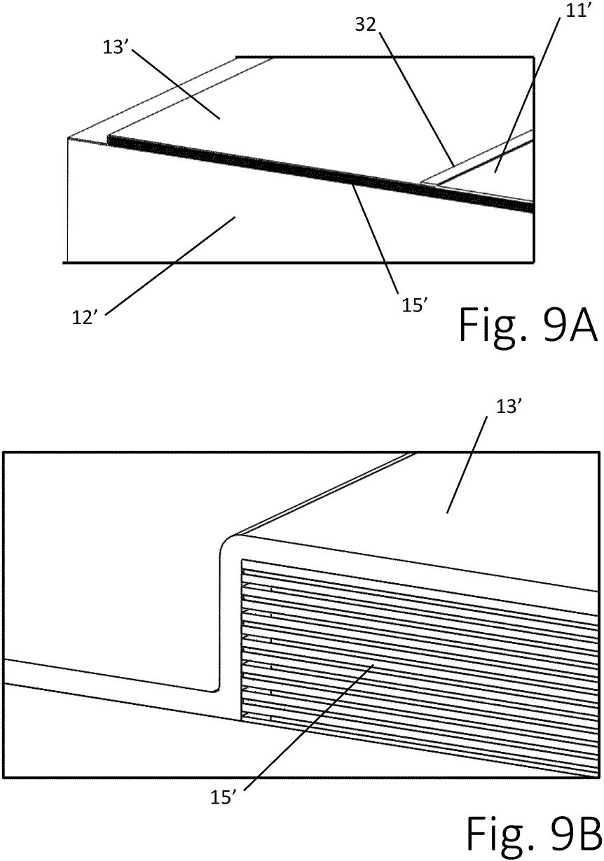

FIGS. 8A and 8B and the figures following illustrate an alternate embodiment of the invention. The alternate embodiment illustrated shares many of the same elements of the preferred embodiment. FIGS. 9A and 9B show that the top insulator 11′ does not extend to the ends of the chip capacitor 2′ as the top insulator 11 does in the preferred embodiment. The first end of the chip capacitor 2′ is similar in function to the first end of the preferred embodiment in that the anode films 21 make electrical contact with the first plated pad 13′, and the cathode films 22 do not. A chief difference is that the top insulator is not present at the ends. The first plated pad 13′ sits directly atop of and is mated with the capacitor film stack 15′.

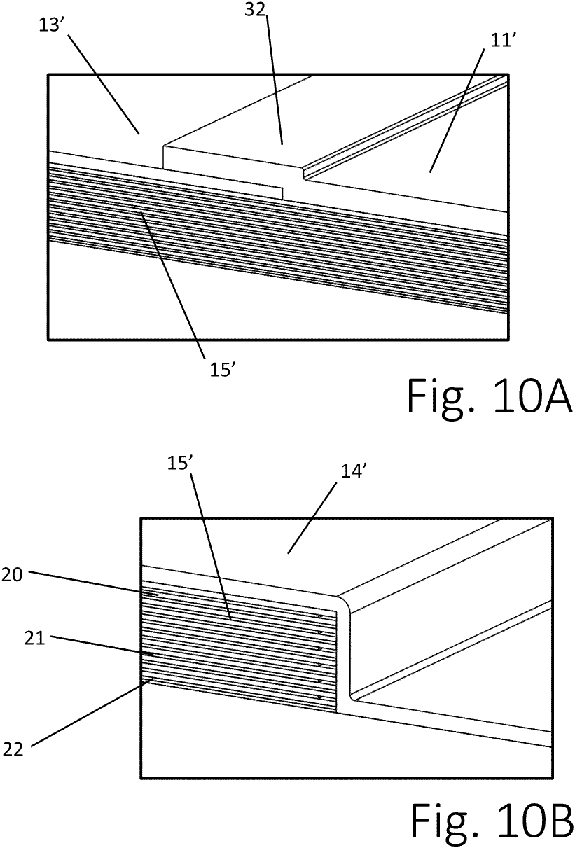

FIGS. 10A and 10B show that the top insulator 11′ extends only to the first plated pad 13′. To facilitate manufacturing, the top insulator 11′ has an extended portion, the overlapping top insulator 32, that overlaps the first plated pad 13′.

FIG. 10B illustrates the second end of the chip capacitor 2′. As with the preferred embodiment, the cathode films 22 make electrical contact with the second plated pad 14′ and the anode films 21 do not. The second plated pad 14′ sits directly atop of and is mated with the capacitor film stack 15′.

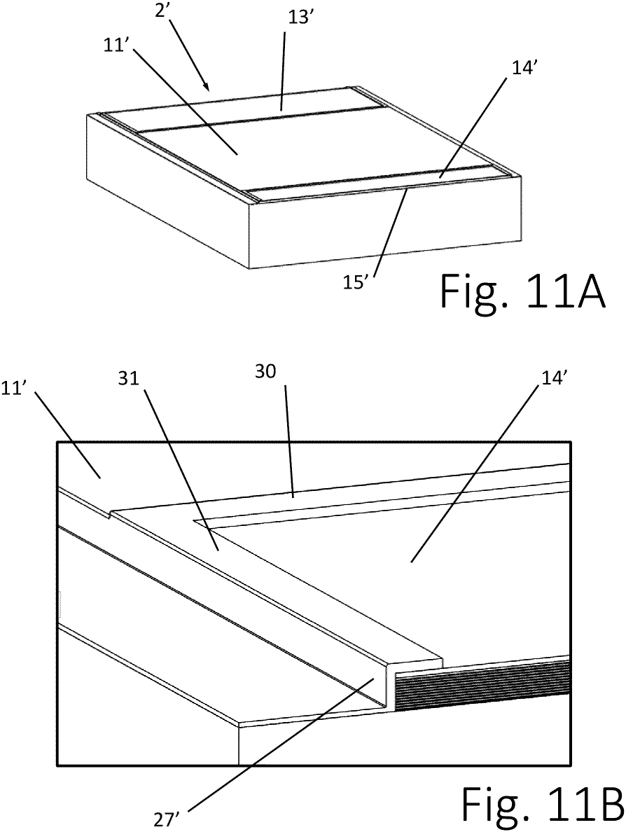

FIG. 11A shows a cross section view of the right plated pad 14′, and FIG. 11B shows a more detailed view. The top insulator 11′ overlaps the sides of the capacitor film stack 15′ and the front and rear portions of the second plated pad 14′. An overlapping insulator 30 and a side overlapping insulator 31 are extensions of top insulator 11′, but are raised due to the thickness of plated pad 14′.

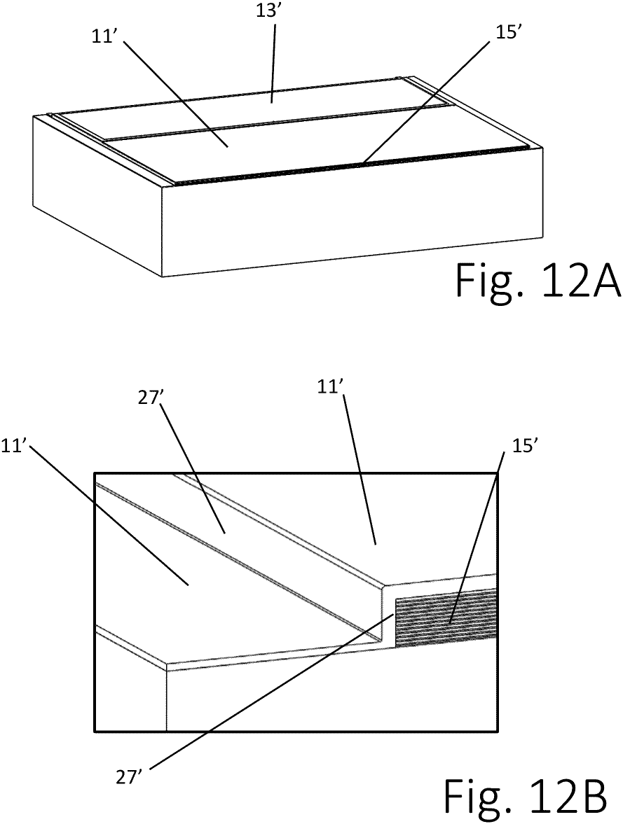

FIGS. 12A and 12B are cross section views at a central area of the chip capacitor 2′. The components of the preferred and alternate embodiment have identical configurations at this cross sectional area.

It should be noted that both of the main embodiments described above would have nearly identical performance characteristics. The two embodiments would however differ in manufacturing steps required and the complexity of the manufacturing process.

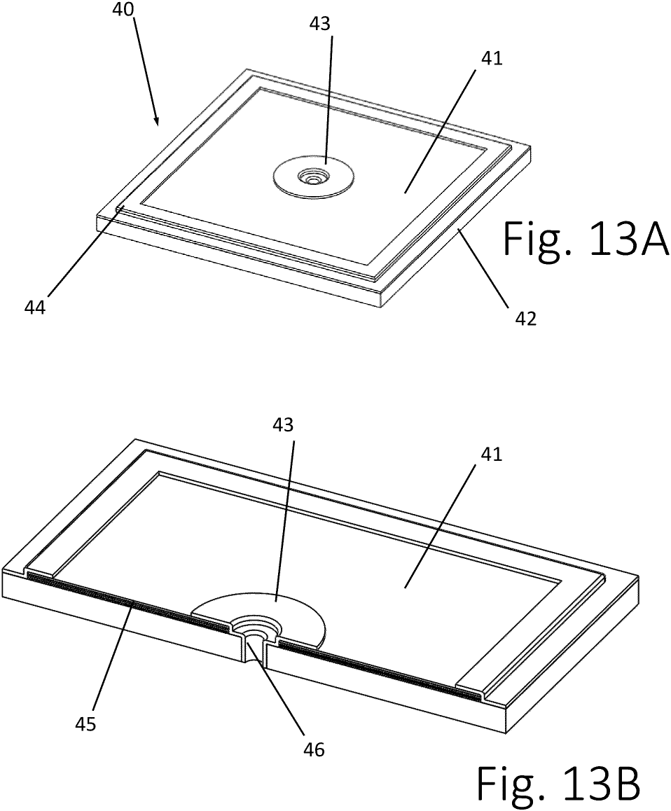

FIGS. 13A and 13B illustrate another preferred embodiment. In this embodiment, the electrical connection pads, the center plated pad 43 and the outer plated pad 44, are located around the perimeter and at a central point of the top surface of the square chip capacitor 40, rather than at the ends of the capacitor as in the chip capacitor 2, 2′. This configuration may be preferred in special high-speed electronics applications.

The center plated pad 43 is located centrally on the top side of the square chip capacitor 40. The outboard plated pad 44 extends around the entire perimeter of the square chip capacitor 40. Most of the remaining top surface real estate is occupied by a top insulator 41 and a film stack 45. A plated through hole 46 allows for electrical connection to the center portion of the square chip capacitor 40 from the bottom side as well as the top side of the square chip capacitor 40.

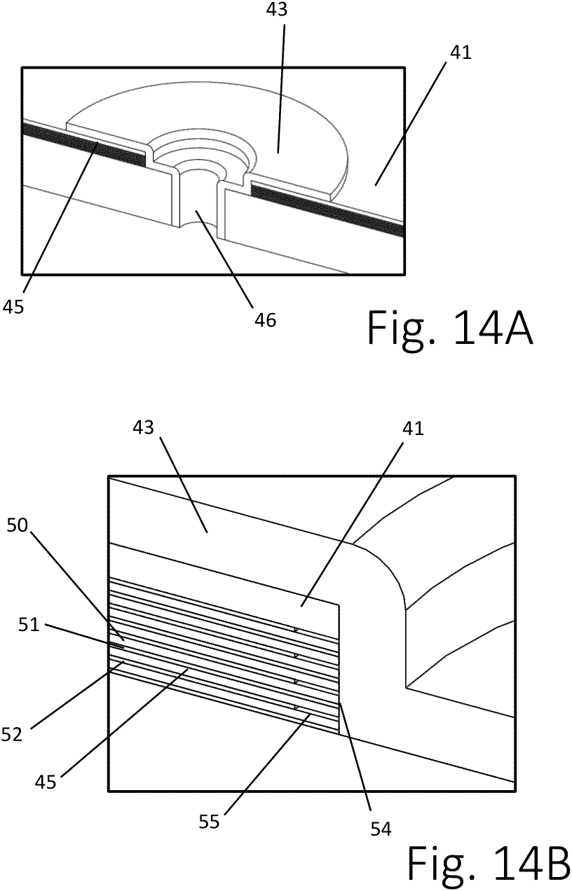

FIGS. 14A and 14B show the center section of the square chip capacitor 40 as sectioned closeup views. The film stack 45 is located between the top insulator 41 and the substrate 42 as in the previously disclosed embodiments. The film stack 45 has a central plated through hole 46. The plated through hole 46 allows for the connection of anode films 51 or cathode films 52. In this example, the anode films 51 are connected to the center plated pad 43 via anode connections 54, while the cathode films 52 are not. The cathode films 52 are electrically isolated from the center plated pad 43 by cathode insulation segments 55. The top insulator 41 sits atop the film stack 45 and has generally the same plan view geometry and dimensions.

The film stack 45 includes anode 51, cathode 52, and dielectric 50 layers that are selectively connected to the center plated pad 43. The anode 51 and cathode 52 layers are formed from two different conductive materials.

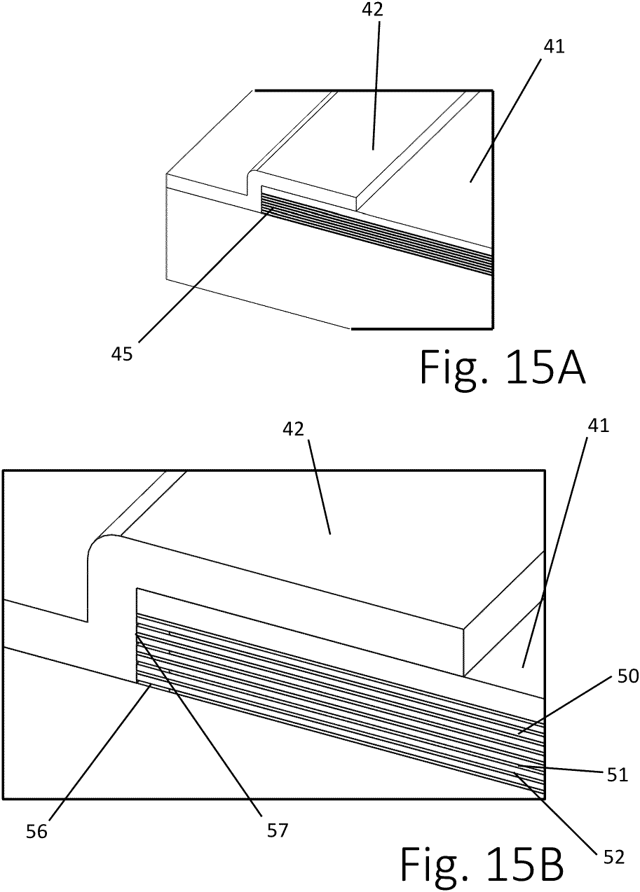

FIGS. 15A and 15B show detailed closeup section views of an edge of the square capacitor 40. FIGS. 15A and 15B show the electrical connection of the cathode films 52 to the outer plated pad 44, with the anode films 51 being insulated from the outer plated pad 44 by the physical separation created by anode insulation 56 at the edges of the square capacitor 40. As in all cases described herein, the anode and cathode connections could be the opposite of what is shown and described, and that alternate design would maintain the same efficacy. It should also be noted that for some applications, design considerations would call for the perimeter of the device to be rounded rather than square. The insulation segments 55 and the anode insulation 56 can be air or a solid as described above in reference to other embodiments.

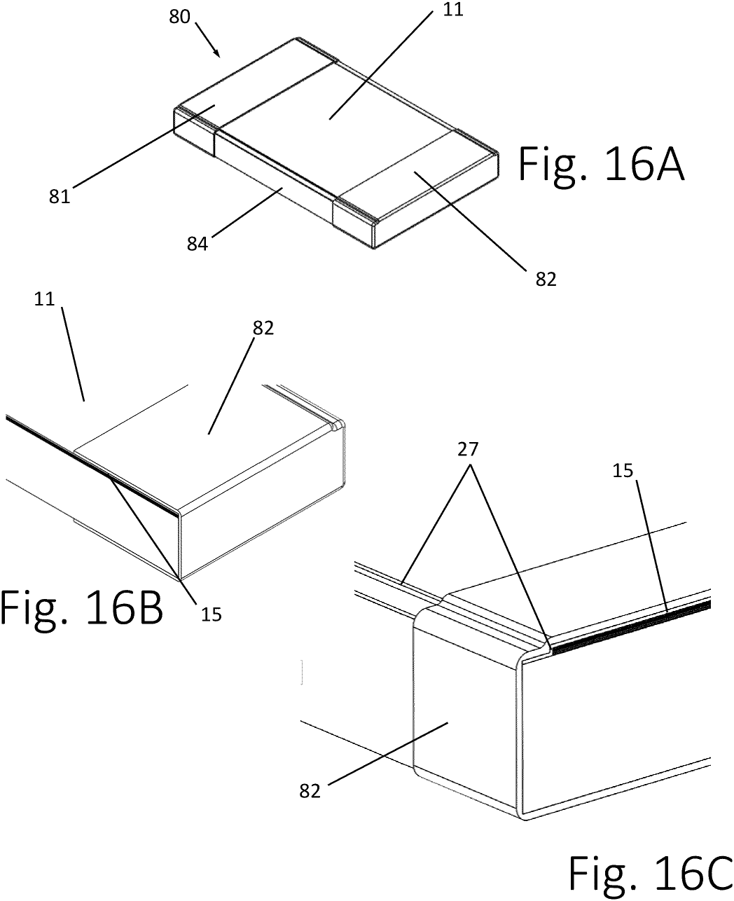

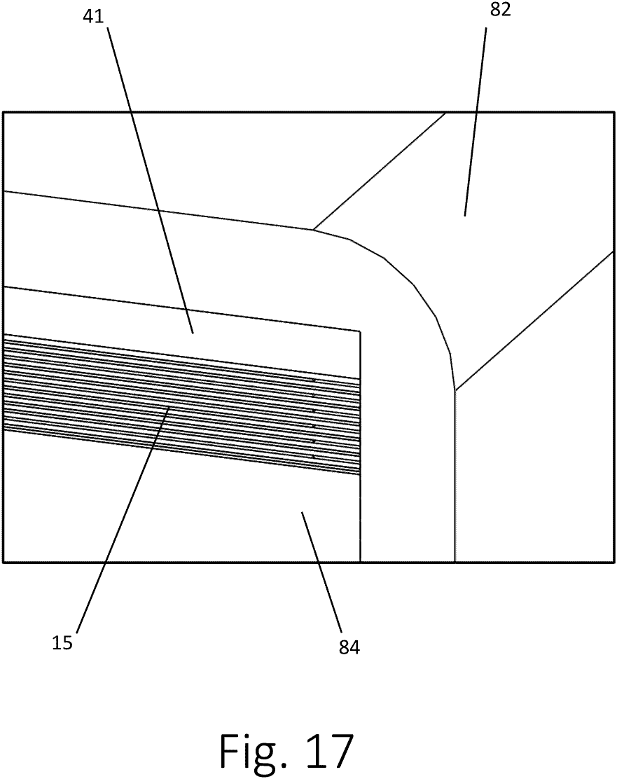

FIGS. 16A-C show still another embodiment of the device, a capped chip capacitor 80, in perspective and sectional views. It is envisioned that the embodiment illustrated in FIGS. 16A-C would not utilize semiconductor type processing where a sheet of material is processed and then diced into chips. The capped chip capacitor 80 would likely be preferred in applications in which the processing of individual components is preferred over the semiconductor approach. The individual component approach is what is generally the state of the art for the manufacturing of many types of discrete capacitors. Using this different approach, a first conductive cap 81 and a second conductive cap 82 are used to make selective connections to the anode films 21 on a first end of the device while making selective connections to the cathode films 22 at a second end of the device. The caps 81, 82 cover the sides of the top insulation layer 11 and the substrate 84. The caps 81, 82 do not make connection with the sides of the dielectric film stack 15 as the caps 81, 82 are insulated from the stack 15 by the side insulator 27. The caps 81, 82 also cover the optional bottom portion of the substrate 84.

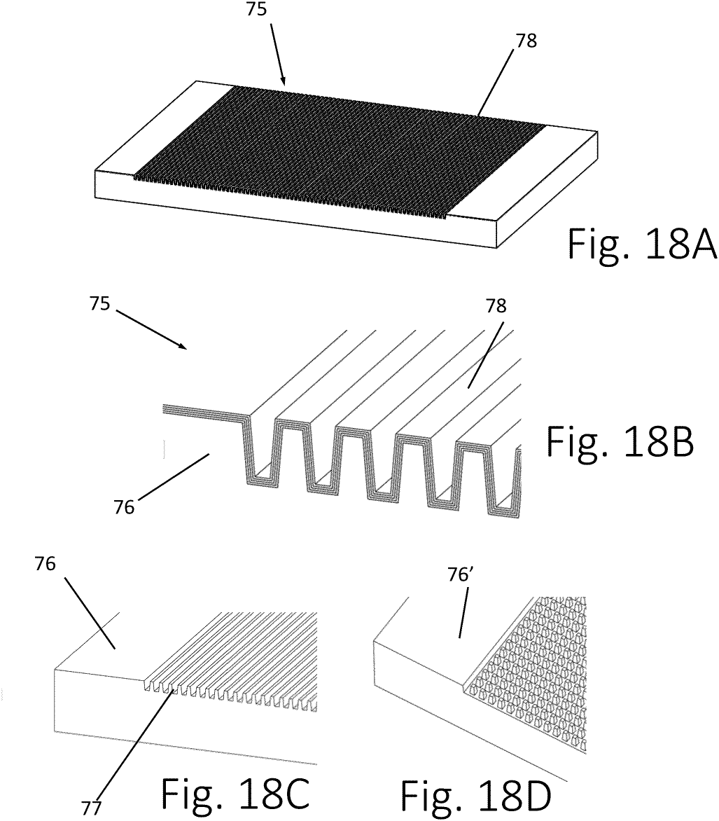

FIGS. 18A-D show another embodiment of the chip with a modified substrate. The embodiment illustrated in FIGS. 18A-D introduce a trenched substrate 76 that includes an array of relatively deep trenches 77. The trenches 77 on the surface that supports the layered stack 78. When the trenched substrate 76 is coated with conductors and dielectrics the overall surface area of the dielectrics and the conductors is increased. The trenched surface area of the illustrated device increases the capacitance by a factor of three over that of an equal sized device without a trenched surface. Thus the capacitance of the device is increased without increasing the overall size of the associated capacitor. It should be noted that the above trenching processes could be applied to all of the embodiments disclosed herein. The trenches 77 are more than twice as wide as the total thickness of the conductors and the dielectrics. Deeper trenches create greater surface area which results in greater capacitance. The depth of the trenches is only limited by the fabrication method and does not have the same limitations as apply to the width of the device.

FIG. 18 D shows a specialized modification of the trenched stack 78. The trenched substrate 76′ utilizes a plurality of posts rather than parallel grooves.

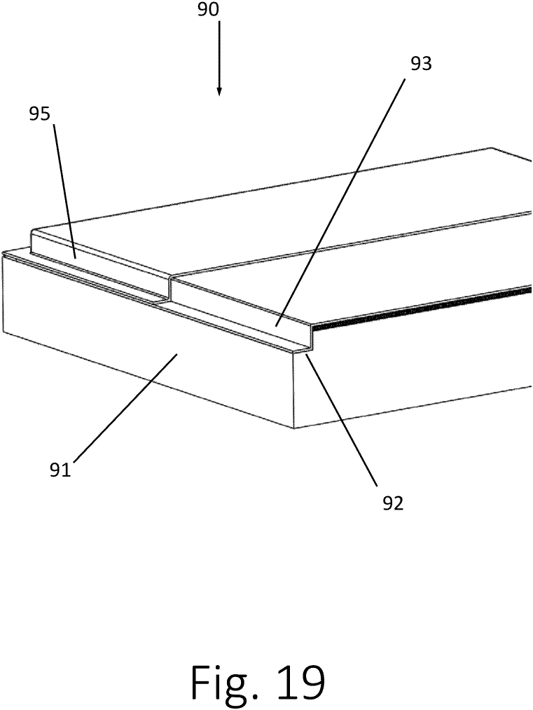

FIG. 19 is a cross sectional view of still another embodiment of the chip capacitor 90. A unique feature of the capacitor chip 90 is that the cut through the capacitor films stack extends into the substrate, a grooved substrate 91. The grooved substrate 91 has a stepped lip around the perimeter, with the top of the groove coinciding with the edges of capacitor film stack. This construction would be preferred when the fabrication process for cutting the perimeters of the capacitor film stack also cuts into the substrate. It should be noted that the horizontal cuts are shown to be the same depth as the vertical cut. This symmetry is not required. In many cases, the two cuts would be produced by two independent operations. With two independent operations, it is unlikely that the two cuts would be the same depth.

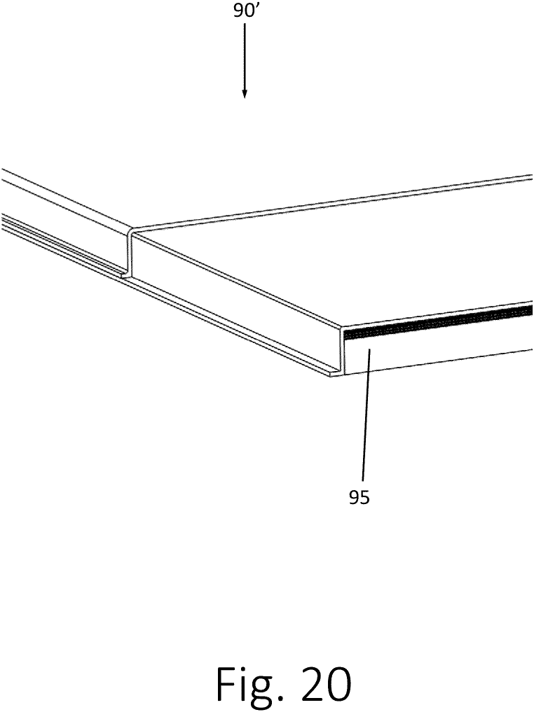

FIG. 20 shows a cross sectional view of still another embodiment. In this thin substrate 90′ configuration, a cut through the capacitor films stack extends completely through a thin substrate 95. The thin substrate 95 has the same perimeter dimensions as that of the capacitor film stack. This configuration would be preferred when the fabrication process includes the temporary bonding of the thin substrate 95 to a thicker, more durable substrate.

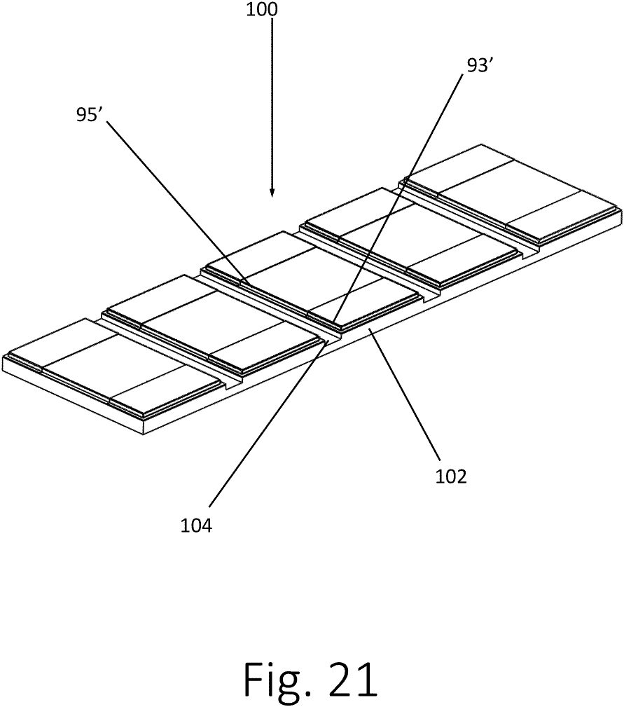

FIG. 21 shows an isometric view of an embodiment which includes an array of discrete capacitors arranged in a linear array 100. The individual capacitors in the capacitor array 100 are electrically isolated from one another by deep cuts 104 that extend through the plated pads, the top insulator, and the capacitor film stack. Array substrate 102 is shown as a grooved substrate, but could also be configured as a flat substrate.

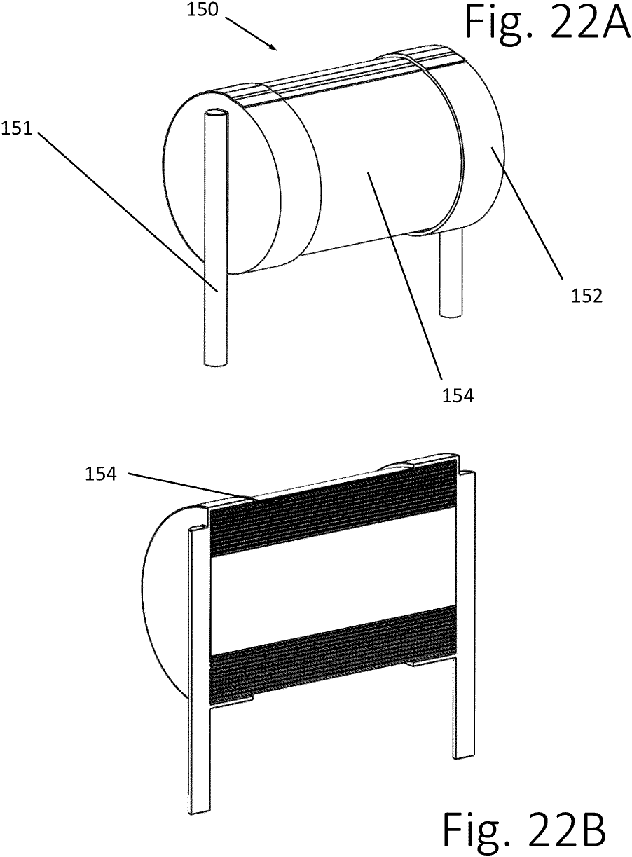

FIGS. 22A and 22B are isometric and section views of a cylindrical embodiment of the capacitor device, a cylindrical capacitor 150. As with other embodiments described above, the anodes are connected to a first conductive cap 152 and the cathodes are connected to a second conductive cap 152. The film stack is configured as a spiral stack 154.

The cylindrical capacitor 150 is a preferred embodiment for the deployment of large capacity capacitor devices.

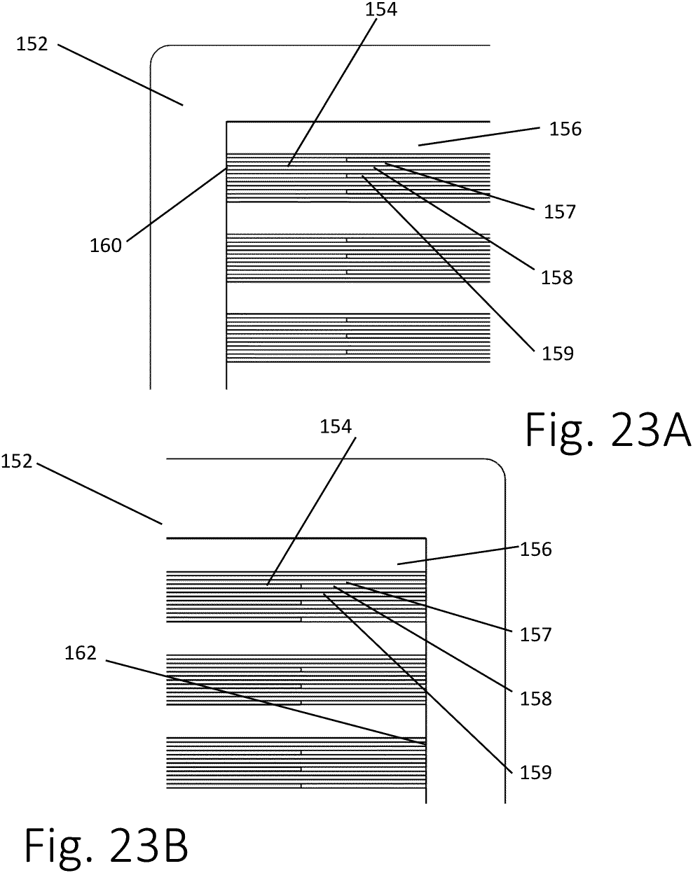

The connections of the cylindrical capacitor 150 can be seen in more detail in FIGS. 23A and 23B. The capacitor film stack 154 winds in a spiral fashion on a spiral substrate 156 around the diameter of the cylindrical capacitor 150. Three short segments of the spiral capacitor film 154 can be seen. Similarly to various other embodiments, the spiral dielectric 157 extends to a conductive cap 152, and along with the anode 160 and cathode 162 (opposite ends for purposes of proper electrical connections), is connected to the conductive cap 152. The electrode that does not make electrical contact to the conductive cap 152 is spaced away from the cap 152 to accomplish the necessary electrical isolation.

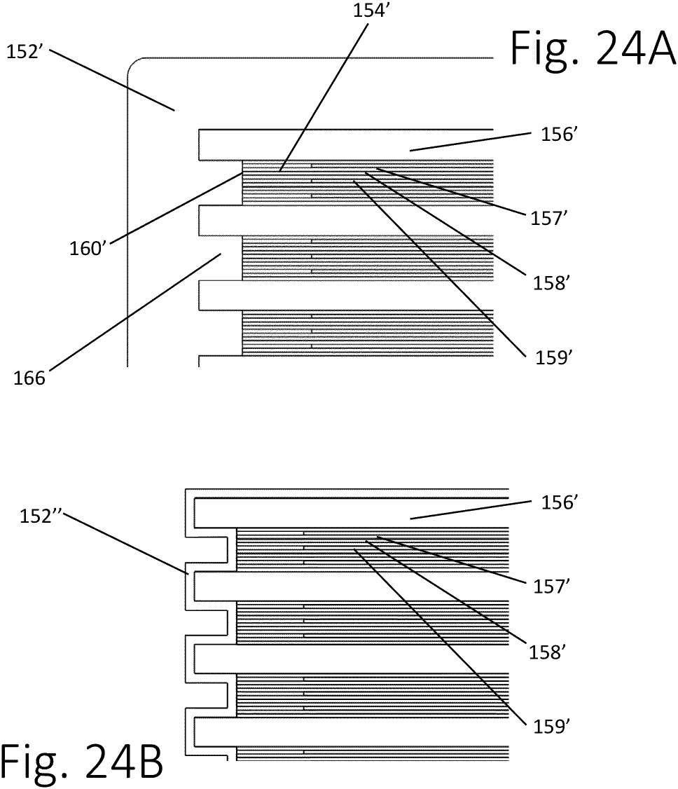

FIG. 24A is a detailed view of a modified cylindrical capacitor. In this particular configuration, the spiral substrate 156′ extends further at its ends, towards the conductive cap 152′, than does the spiral dielectric film 157′, the anode film 158′, and the cathode film 159′. The longer extending spiral substrate 156′ leads to the formation of structural fill elements, ribs 166, in the conductive caps 152′. The ribs 166 in the conductive caps 152′ provide structural strength in the area where the anode films 158′ and cathode films 159′ make electrical connection to the conductive caps 152′. The added structural strength reduces the stress on the essential electrical connections of the anodes 158′ and cathodes 159′ to the conductive caps 152′, thereby reducing the possibility of electrical failures.

FIG. 24B is a detailed view of another modified cylindrical capacitor. This configuration includes modified conductive caps 152″. The conductive caps 152″ are reduced in thickness, and follow the contours of the spiral substrate 156′, the spiral dielectric film 157′, the spiral anode film 158′, and the spiral cathode film 159′. This configuration might be deployed when thin conductive caps 152″ (plated pads) are preferred for manufacturability or to reduce material usage. The thickness of the conductive caps 152″ might be only a few microns rather than fractions of a millimeter.

All of the embodiments described above disclose a short path from the anodes and cathodes to the plated pads.

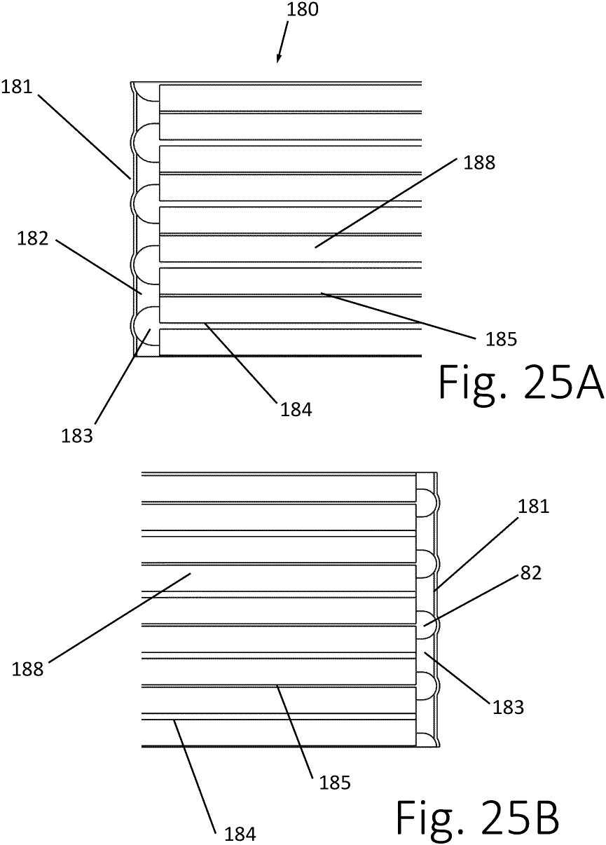

FIGS. 25A and 25B show still another configuration in which the connections of the anodes 184 and cathodes 185 to conductive caps 181 are made with an intermediate component, a film plating 183. The film plating 183 is created by selectively electro plating either the anodes or the cathodes. When the anode is connected to a voltage source, plating collects to create the semi-circles illustrated at the anodes and not the cathodes. To create the cathode connections, the voltage source is connected to the cathodes. The plating process lengthens and widens the anodes and the cathodes, forming the half round geometry illustrated. The film plating 183 adds durability, conductivity, and length to the anodes 184 and the cathodes 185. This configuration is only practicable when the charge storage film 188 is much wider than the anode 184 or cathode 185 films. The pad insulator 182 is located between the film plating 183, the plated conductive cap 181, and the charge storage film 188 to ensure that only the desired anode or cathode films are electrically connected to the conductive cap 181.

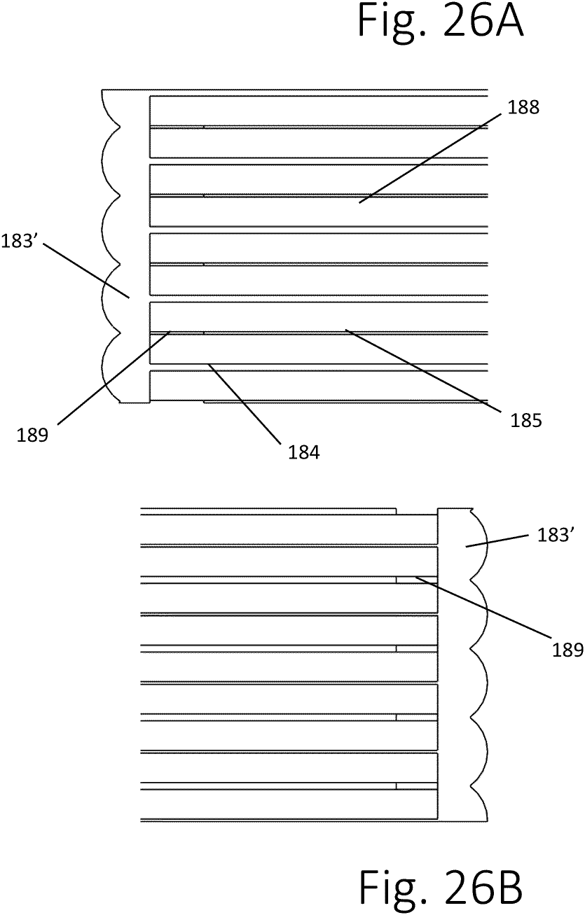

FIGS. 26A and 26B show a construction in which the plating has been increased to a point where the film plating 183′ from one layer connects to the neighboring films. This allows the film plating 193′ to replace the function of the usually present conductive cap, and therefore eliminate the need for the conductive caps. In this configuration, the anode or cathode, whichever is to be electrically isolated from the film plating 183′, would be etched back from the edge of the film stack to ensure there is no electrical connection.

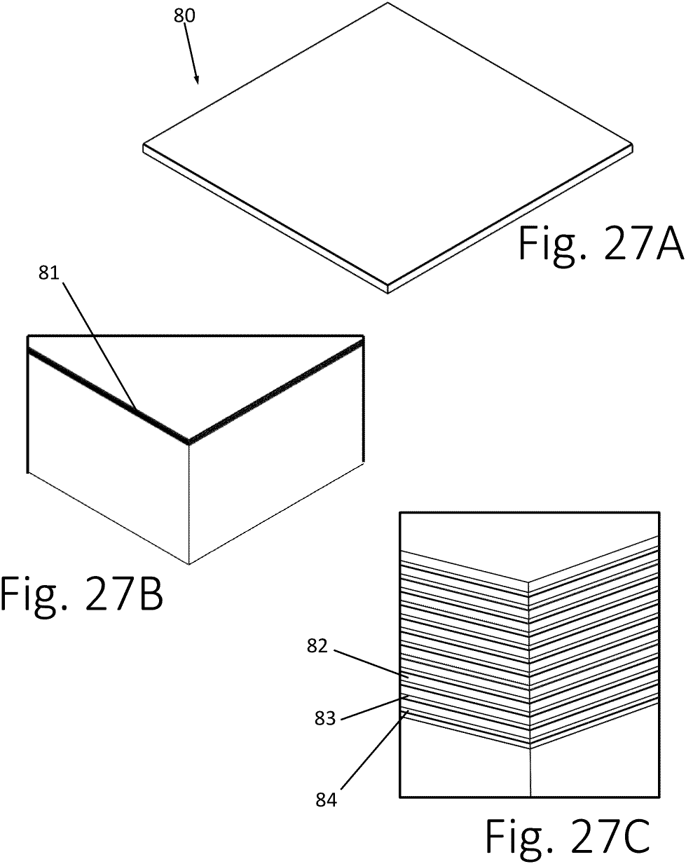

FIGS. 27A-C through 35 show the steps of a preferred process for construction of the chip capacitors described herein. FIGS. 27A-C show the first phase of the manufacturing process, where alternating layers of the dielectric film 20, the anode film 21, another layer of the dielectric film 20, and the cathode film 22 have been laid on top of the substrate 12. Large sheets or rolls of substrate and film layers can be processed and cut into smaller sections, as required. Deposition of layers on large sheets or rolls is a fairly common process. An everyday example of roll to roll deposition coating of a conductor on a substrate is packaging for potato chips. Most products of this type have an aluminum coating applied. The type of machine that creates the aluminum film can be used to apply dielectrics and many types of conductors. Coating of glass for displays is another example where thin layers of conductors and dielectrics are applied with a high degree of accuracy, at a low cost.

The preferred method to create the capacitor film stack is with semiconductor type equipment and materials. Another method would be to assemble or laminate discrete films or to create films on top of one another with a liquid solution.

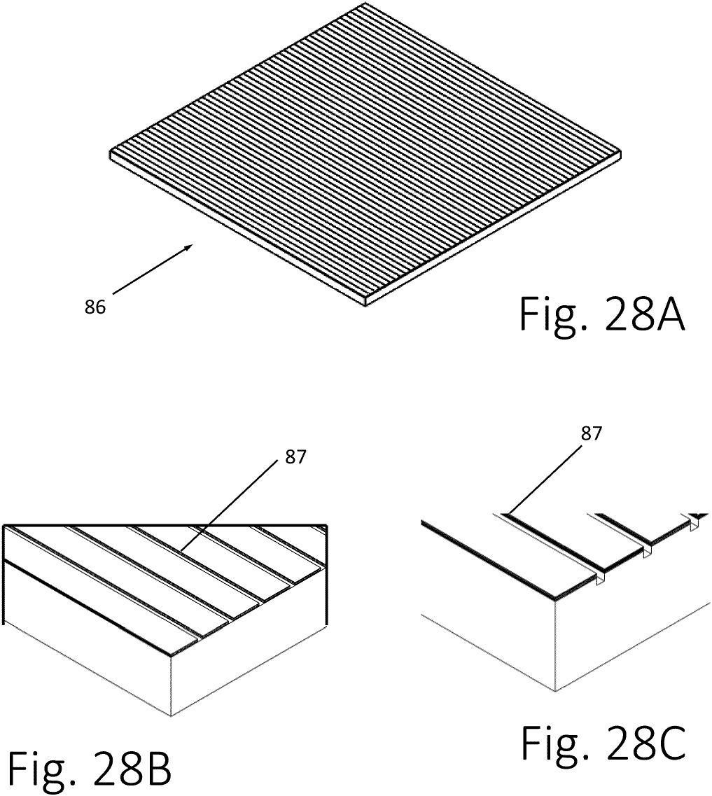

Referring now to FIGS. 28A-C, the results of a second step of fabrication is shown. In this phase the rows of grooves 87 are created horizontally across the capacitor film stack 86. The grooves 87 could extend into the substrate if desired to ease manufacturability. The grooves 87 are spaced apart at approximately the overall width of the chip capacitor. The grooves 87 can be created with conventional semiconductor processes or they can be cut with a saw or a laser. FIG. 28B shows the grooves extending only down to the substrate. FIG. 28C shows an alternated configuration with the grooves extending partially into the substrate. If a carrier wafer is deployed, a second substrate attached to the bottom of the substrate shown, the cut may extend all the way through as disclosed in FIG. 20.

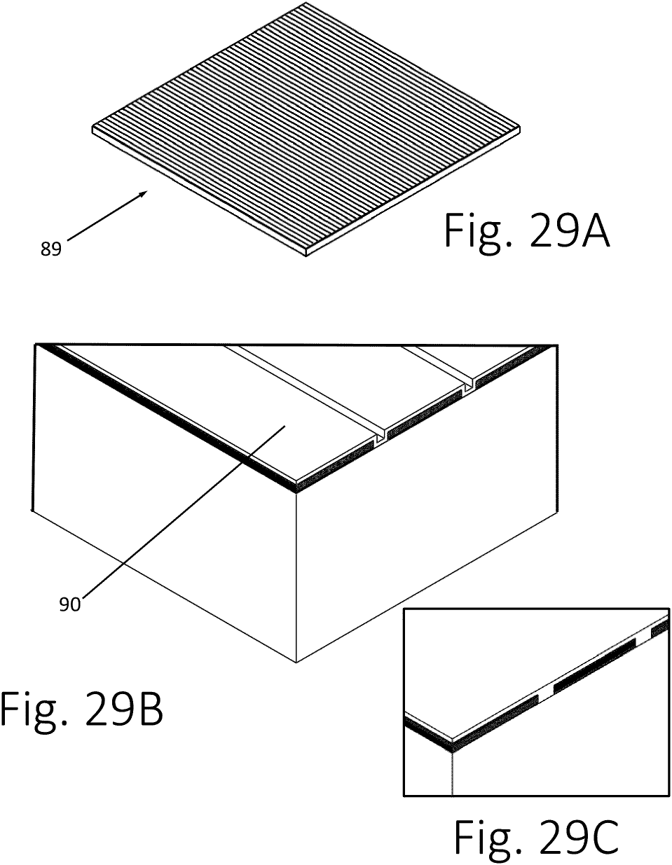

FIGS. 29A-C show a third successive step in the processing which entails the coating the panel 89 via deposition of an insulating material 90. This deposition creates a top insulator and the side insulators. The deposition of the insulating material to form the top insulator 11 and the side insulators 27 can be accomplished with semiconductor type equipment, or with a number of less complex processes such as spraying, spin coating, printing, dipping, or other similar methods.

FIG. 29B depicts the insulating material to be of a generally uniform thickness conforming to the contour of the top surface of the panel 89. This is not a requirement. Some deposition methods might entirely fill the grooves with insulating material, thereby creating a flat top surface as shown in FIG. 29C.

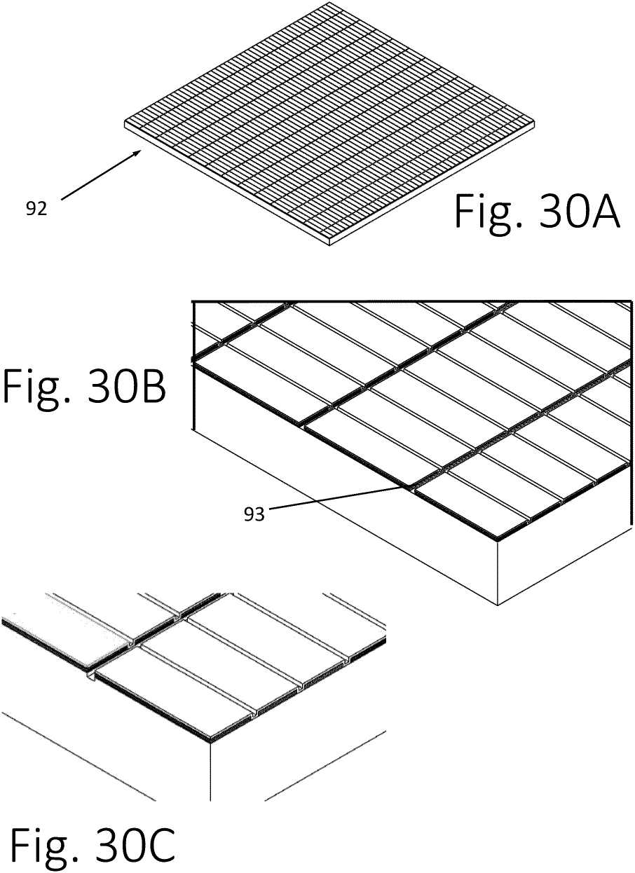

FIGS. 30A-C show a fourth phase of the processing. In this phase, columns of grooves 93 are created vertically through the capacitor film stack panel 92. Similarly to the horizontal grooves 87, the vertically aligned grooves 93 could extend into the substrate 12 as shown in FIG. 30C if desired for manufacturability reasons. The vertically aligned grooves 93 are spaced apart at approximately two times the overall length of the chip capacitor being manufactured.

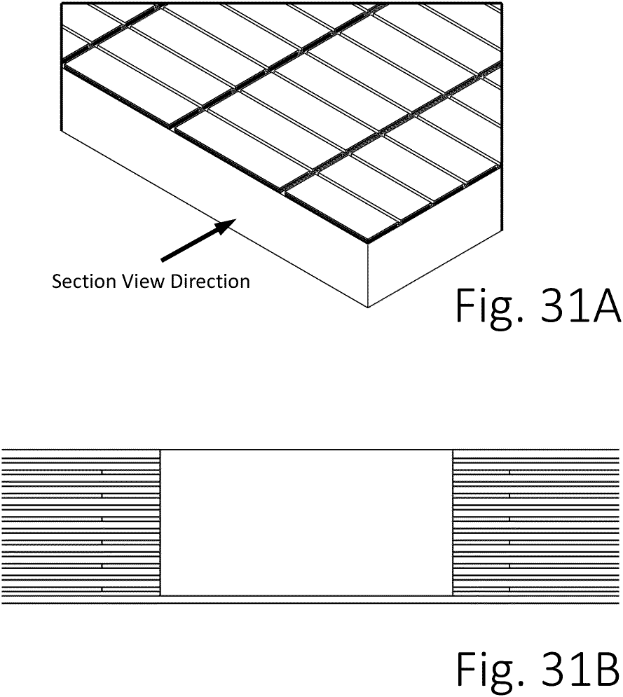

FIGS. 31A-B depict a fifth phase of processing. In this phase, the ends of the cathode films are aggressively etched with a chemical solution that does not etch the anode films. It should be noted that the cathode films on both sides of the grooves are etched. This process allows the selective electrical connection of the anode films, the etched areas leaving the cathode films without an electrical connection to the plated pad or conductive cap, as described in following process steps.

To create the selective electrical conductivity connections, the two different conductor layers (cathodes and anodes) are made from two different conductors. One exemplary method would be to form the anode films 21 from aluminum (Al), and the cathode film 22 from copper(Cu), with the dielectric layer being made from silicon dioxide (SiO2). Many etchants are available to selectively etch copper while not etching aluminum or dielectric materials. The most straightforward way to accomplish the selective etch is to submerge the entire coated substrate / panel in the etching solution.

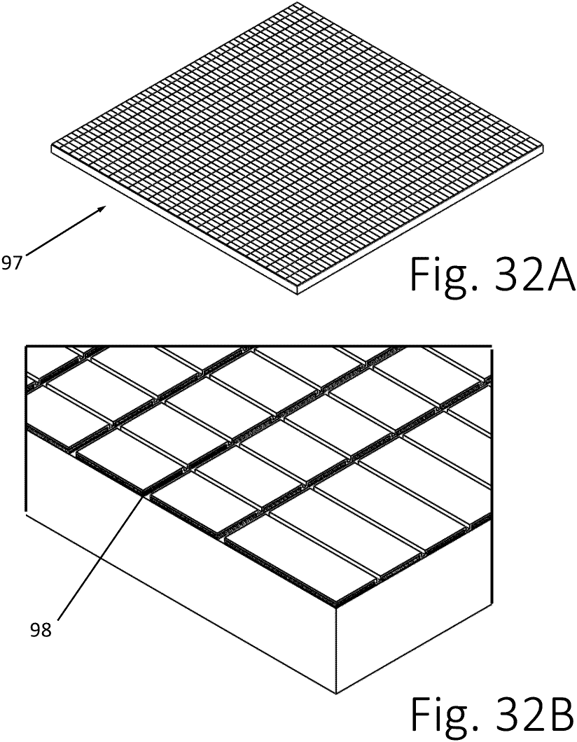

FIGS. 32A-B show a sixth phase of processing. In this phase, a second set of vertically oriented grooves 98 are cut through the capacitor film stacks of the panel 97. The second vertical grooves 98 are typically positioned halfway between each pair of the first set of vertical grooves.

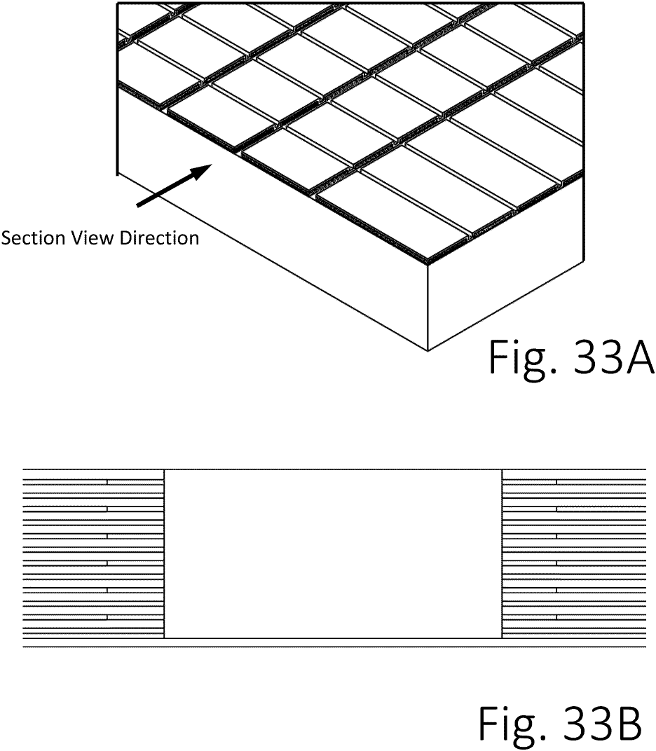

FIGS. 33A-B depict the seventh phase of the processing. In this phase, the cathode films are aggressively etched with a chemical solution that does not significantly affect the anode films. This process is analogous to the first etch that selectively etches the anode films. As with the first anode etch process, the cathode films on both sides of the grooves are etched. In the cathode etch, the first set of grooves must be isolated from the cathode etch material. The isolation can be accomplished by only locally filling the grooves with the etchant. The isolation could also be created by applying a resist material to the first set of grooves or their general area. Another method would be to cover the first set of grooves with an elastic pad material. The preferred method is to apply resist to the entire panel before the second set of vertical grooves are cut.

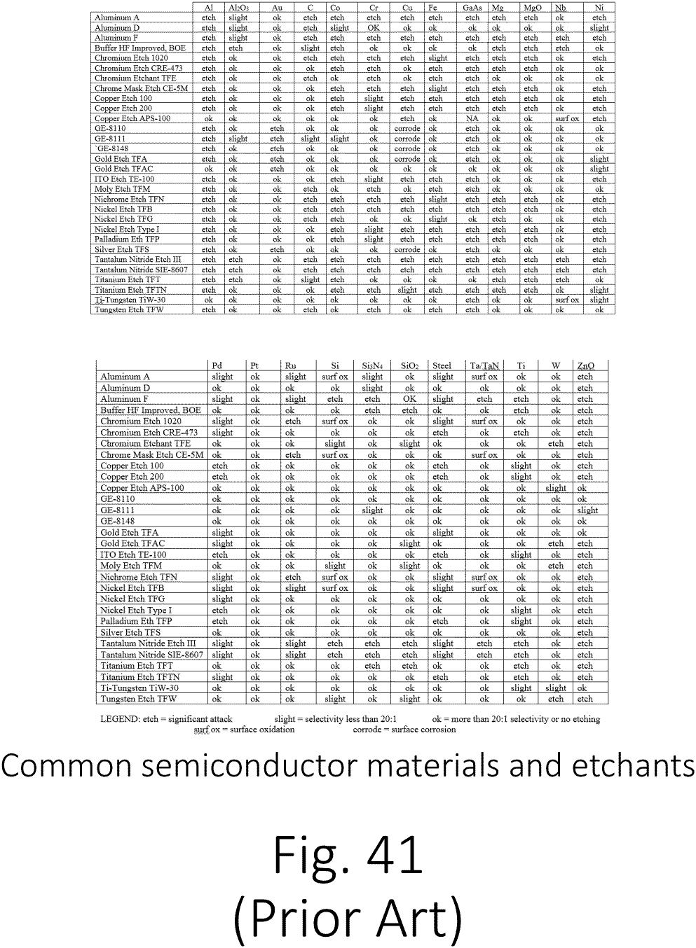

During this phase, the copper at the end of the cathode films is etched back while the aluminum of the anode films, and the dielectric films, are not etched so that a non-conductive gap is formed at the ends of the cathode films. An etching solution of copper (Cu) and iron chloride (FeCl3) can be deployed to accomplish this task. One skilled in the art of chip conductors and / or etching of conductors could engineer many different combinations of conductor materials and selective etchants for a particular application of the chip capacitor. See FIG. 41 for a list of metals and their etchants.

An optional process to the above would be to cut all of the vertical grooves in one operation. This would require the selective etching of both types of grooves rather than one at a time as described. This process would require multiple etching steps and associated masking.

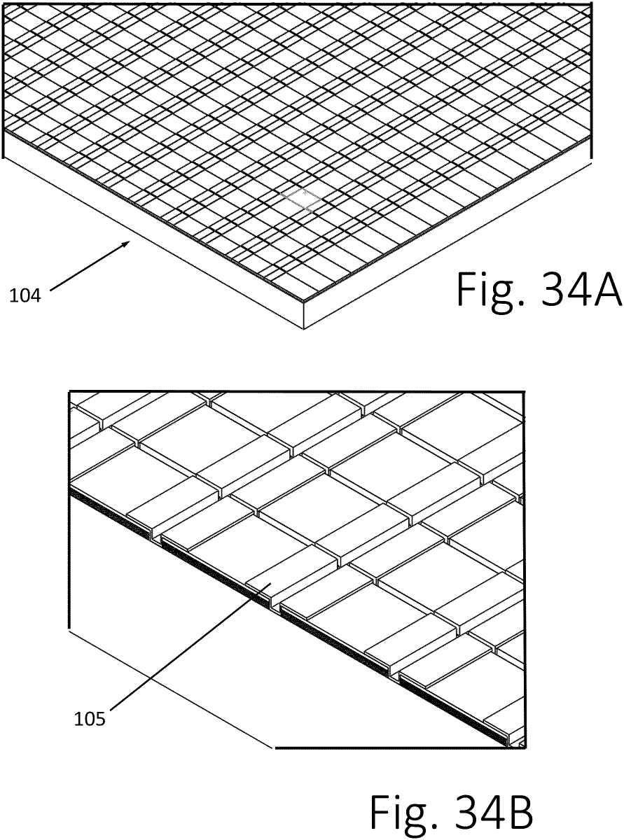

FIGS. 34A-B show the eighth phase of processing, the deposition of a conducting material. This deposition creates the first 13 and second 14 plated pads. The deposition of the conducting material can be done with semiconductor type equipment. It can also be deposited with a number of less complex processes such as spraying, spin coating, printing, plating, silk-screening, dipping or other methods that cover the top insulator 11 and the side insulators 27 with a conductive material. As mentioned above, the conductive material is generally of a uniform thickness conforming to the contour of the top surface of the panel 104. This is not a requirement. Some deposition methods might entirely fill the grooves with insulating material, thereby creating a flat top surface.

The conductive material can be copper, nickel, silver, gold, aluminum, or other materials. With most application methods, the entire surface may need to be covered. When the entire surface is coated, another process step would be required to remove the conductor material between the left and right plated pads. In the case of printing and silk-screening, the conductive material could be applied to only the intended areas, the first and second plated pads 105, thereby eliminating the need to remove the material between the pads. The main purpose of this process is to connect the anodes to one set of pads and the cathodes to the other while electrically isolating the two sets of pads.

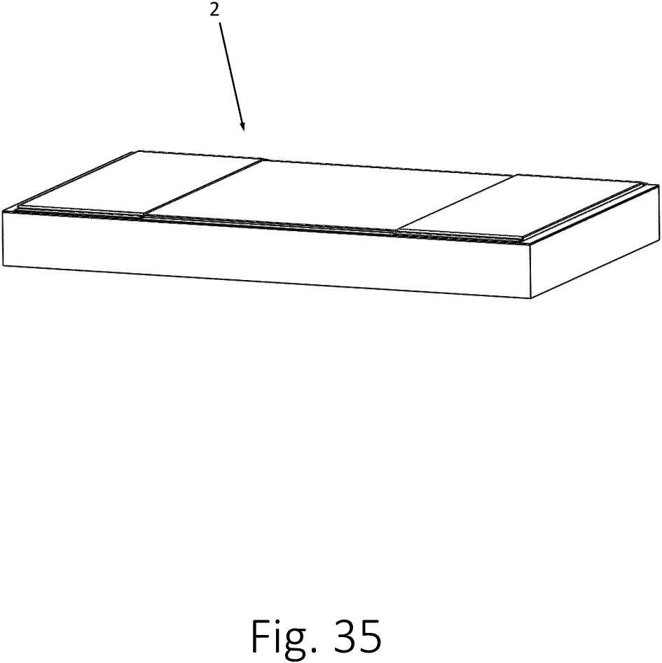

FIG. 35 shows the final phases of processing, electroplating, testing, and dicing. In the final phase, a number of optional processes can be deployed. One option is that additional metals can be electroplated on top of the pad material for durability and solderability. With current state of the art chip capacitors, the base conductor is typically copper with a second layer of nickel and a final layer of tin. Another optional operation at this phase would be to test and / or mark the chip capacitors. A final operation would be to cut the sheet of material into the individual chip capacitors.

FIG. 36 shows the equation to calculate the capacitance of capacitors and an associated schematic diagram.

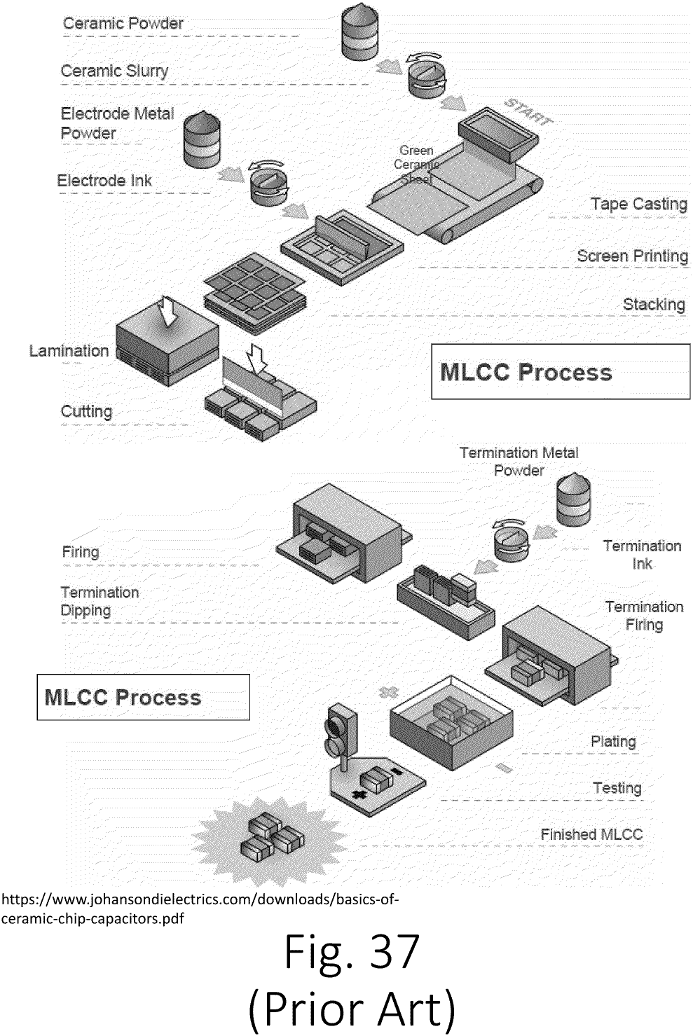

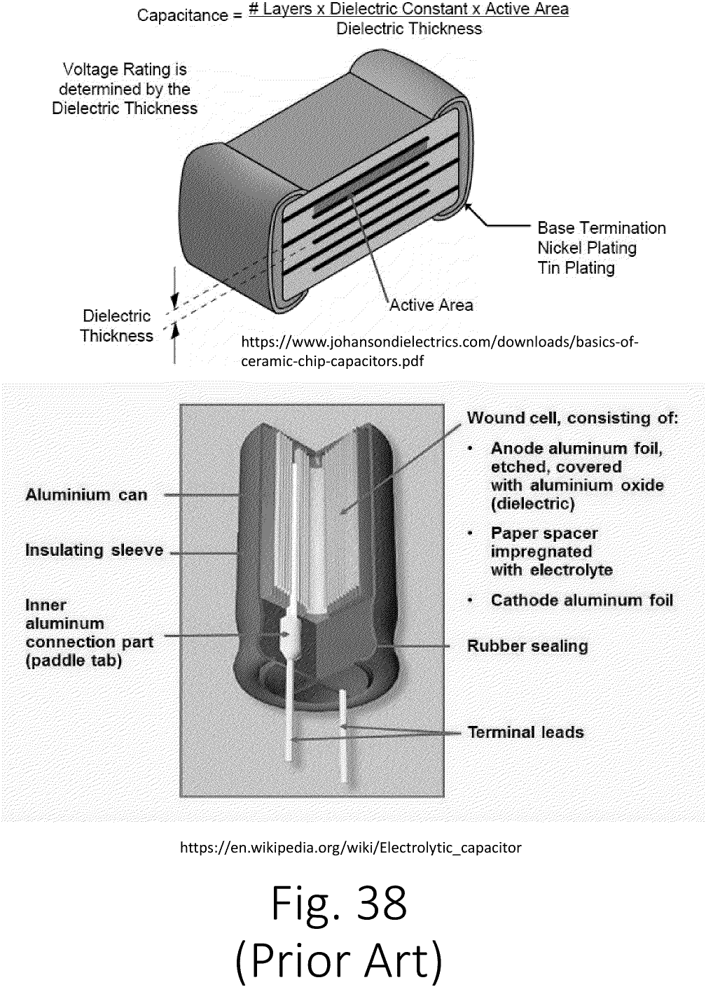

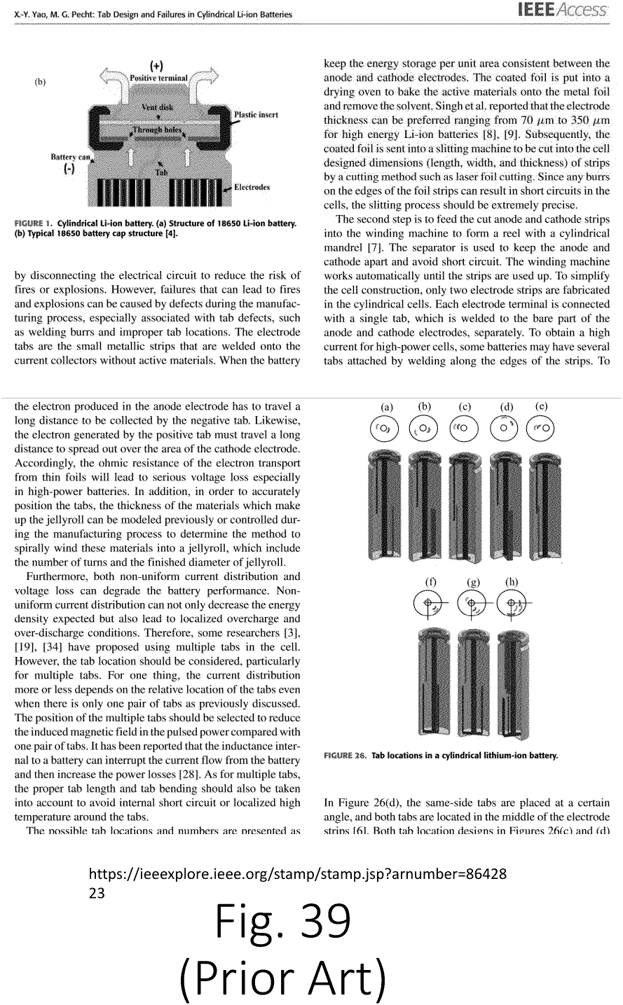

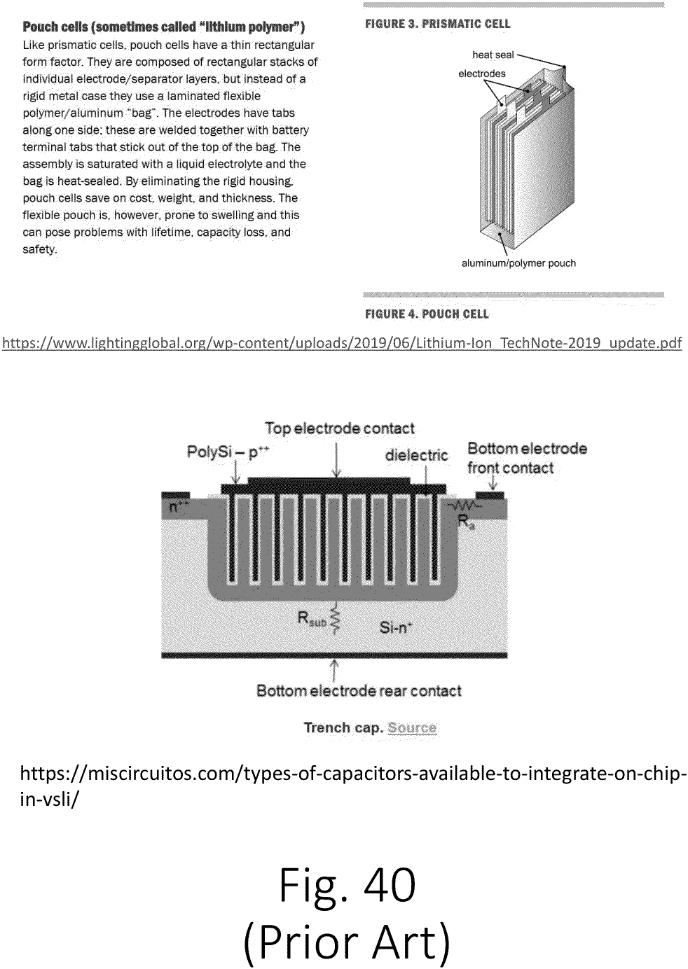

FIGS. 37 through 41 disclose prior art information on capacitors, materials used as dielectric and etchants and their effectiveness in etching conductors and dielectrics.

The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the Figures are merely schematic representations of the present disclosure. As such, some of the components may have been distorted from their actual scale for pictorial clarity.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE’s or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various Figures (including component diagrams) shown and discussed herein are for illustrative purpose only, and are not drawn to scale.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A capacitor device comprising:
a plurality of anode layers;
a pair of dielectric layers sandwiching each of the anode layers;
a plurality of cathode layers, each of the cathode layers also being sandwiched between a pair of dielectric layers, the anode, cathode, and dielectric layers forming a capacitor film stack; wherein
each of the anode layers are electrically connected at a first end to at least another one of the anode layers, and
each of the cathode layers are electrically connected to at least another one of the cathode layers at a second end opposite the first end, each of the cathode layers being electrically isolated from the anode layers, and
both sides of the conductor layers and dielectric layers are encased by side insulating material.

2. The device according to claim 1, wherein a top surface of a top layer of the capacitor film stack is covered with an insulating material.

3. The device according to claim 1, wherein a bottom surface of a bottom layer of the capacitor film stack is covered with a bottom insulating material.

4. The device according to claim 3, wherein the bottom insulating material extends beyond sides of the bottom layer.

5. The device according to claim 3, wherein sides of the bottom insulating material are coincident with sides of the bottom layer.

6. The device according to claim 1, wherein all of the anode layers and the cathode layers extend to the side insulating material.

7. The device according to claim 1, wherein all of the anode layers, the cathode layers, and the dielectric layers extend to the side insulating material.

8. The device according to claim 1, wherein the planar dielectric layers are less than 150 nm in thickness.

9. The device according to claim 9, wherein there are over 200 dielectric layers.

10. The device according to claim 4, wherein side insulating material extents to the sides of the bottom insulating material.

11. The device according to claim 1, wherein a bottom insulating material covers a bottom layer of the planar capacitor film stack and extends beyond ends of the bottom layer.

12. The device according to claim 11, wherein the electrical connections extend from a top surface of the bottom insulating material to a top surface of a top layer.

13. The device according to claim 12, wherein the extended end connections are connected to a truncated conductor plane situated atop the top layer.

14. The device according to claim 1, wherein the electrical connections extend from a bottom surface of a bottom layer to a top surface of a top layer.

15. The device according to claim 14, wherein the electrical connections are connected to a truncated conductor plane atop the top layer.

16. The device according to claim 1, wherein the anode layers are formed from a different material than a material that forms the cathode layers.

17. The device according to claim 16, wherein a first chemistry process is used to selectively etch only the anode layers and a second chemistry process is used to selectively etch only the cathode layers.

18. A capacitor device comprising:
a plurality of anode layers with a pair of dielectric layers sandwiching each of the anode layers;
a plurality of cathode layers, each of the cathode layers also being sandwiched between a pair of dielectric layers; wherein
each of the anode layers is electrically connected to at least another one of the anode layers at points near the perimeter of the anode layers; and
each of the cathode layers is electrically connected to at least another one of the cathode layers at central points of the cathode layers, each of the cathode layers being electrically isolated from the anode layers.

19. The device according to claim 18, wherein multiple layers of anodes, cathodes, and dielectrics are located on a bottom insulating material and are separated to form a plurality of capacitor film stacks.

20. A capacitor device comprising:
a plurality of anode layers, the layers being in a spiral configuration;
a pair of dielectric layers sandwiching each of the anode layers;
a plurality of cathode layers, each of the cathode layers also being in a spiral configuration and being sandwiched between a pair of dielectric layers; wherein
each of the spiral anode layers are electrically connected to at least another one of the anode layers; and
each of the spiral cathode layers are electrically connected to at least another one of the spiral cathode layers at and end opposite the electrical connection, and each of the cathode layers are electrically isolated from the anode layers.

21. The device according to claim 20, wherein the multiple sets of anode layers and dielectric films and cathode layers and dielectric films are separated by a structural supporting film.

22. The device according to claim 21, wherein the dielectric films are less then 200 nm in thickness.

23. A capacitor device comprising:
a plurality of anode layers with a pair of dielectric layers sandwiching each of the anode layers;
a plurality of cathode layers, each of the cathode layers also being sandwiched between a pair of dielectric layers; wherein
each of the anode layers are electrically connected to at least another one of the anode layers at a first end of the anode layers, and each of the cathode layers are electrically connected to at least another one of the cathode layers at an end of the cathodes opposite the end of the anode to anode electrical connections in a capacitor film stack, each of the cathode layers being electrically isolated from the anode.

24. A capacitor device comprising:
a plurality of anode layers;
a pair of dielectric layers sandwiching each of the anode layers;
a plurality of cathode layers, each of the cathode layers also being sandwiched between a pair of dielectric layers, the anode, cathode, and dielectric layers forming a capacitor film stack; wherein
each of the anode layers are electrically connected at a first end to at least another one of the anode layers, the anode electrical connections being formed by a first selective electroplating process, and
each of the cathode layers are electrically connected to at least another one of the cathode layers at a second end opposite the first end, the cathode electrical connections being formed by a second selective electroplating process, each of the cathode layers being electrically isolated from the anode layers.
